(19) United States
(12) Patent Application Publication
(10) Pub. No.: US 2010/0100535 A1
(43) Pub. Date: Apr. 22, 2010

(54) ENTERPRISE APPLICATION PLATFORM

(76) Inventor: Michael Melancon, Baton Rouge, LA (US)

Correspondence Address: Neil J. Coig, P.O. Box 15928, Baton Rouge, LA, 70895, US

(21) Appl. No.: 12/579,401

(22) Filed: Oct. 14, 2009

Related U.S. Application Data
(60) Provisional application No. 61/105,770, filed on Oct. 15, 2008.

(51) Int. Cl. G06F 17/30; G06F 9/46; G06F 3/048

(52) U.S. Cl. 707/706; 718/100; 715/764; 707/E17.108

(57) ABSTRACT

The present invention is an improved ERP system which provides for complete integration of systems across an enterprise in an infinitely expandable and easily deployable platform offering a vast reduction in overhead and learning curve, as well as extensive authoring, search, security and automation features.

### CONTINUATION HISTORY

This application is a continuation of U.S. Patent Application 61,105,770, filed on Oct. 15, 2008, which is hereby incorporated by reference in its entirety.

### BACKGROUND OF THE INVENTION

The present invention relates to a method and software for the integration of computer data systems across an enterprise. In the traditional mode of integration of data, known commonly as enterprise resource planning (ERP), an enterprise, that is, a business, individual or other entity desirous of storing data for different purposes, may use an ERP software package to store and manipulate data records for use by its employees, customers and the like. In order to effect this data storage and retrieval, enterprises have historically used several varied software programs and packages to perform different tasks with this data. For example, an enterprise may want to store its customer data for several different purposes, such as pre-sales customer resource management (CRM), sales support, billing, post-sale follow-up, warranty service and customer service. Each of these areas of the enterprise is likely to exploit the same basic customer record, but in very different ways, and with completely different sets of data. For example, a customer's data in the billing department is likely to have very little in common with the customer's data in the warranty department, outside of basic information such as name and contact details. An enterprise would therefore likely have different programs to manipulate and store this data, creating various problems, such as data duplication across the enterprise, data inconsistency among the systems, and a general lack of continuity for the customer throughout the course of its relationship with the enterprise.

In the current state of the art, enterprise resource planning software seeks to eliminate these incongruities by unifying the data in a single software package. More to the point, rather than having multiple software packages performing different functions, ERP software packages seek to consolidate these functions into a single location and interface. While many offerings are currently available to the consuming public, most, if not all, utilize a modular system that is predefined by the ERP software provider. In this fashion, a core system is provided, and an ERP software customer may choose one or more modules to add to this core system in order to provide functionality. Examples of these so-called modules may include a billing module, a customer resource management (CRM) module and the like—essentially resulting in a module for each area of the enterprise that is likely to utilize the data. Though this method results in an appearance from the interface that data is truly integrated, in actuality, the various modules are working behind the scenes to be “stitched together,” often haphazardly, and are simply presented to the user in a more unified format, all the while preserving a certain level of data segmentation due to the modular nature of existing ERP software. Though admittedly existing ERP reduces data segmentation to some degree, a tool which truly blends data with its function has yet to be offered, until the present invention.

Obvious downsides to the current mode of modular ERP software exist, not the least of which is the fact that an enterprise is limited to the ways in which they can manipulate the data to the extent that the chosen ERP software provider offers suitable modules. In other words, if the need by the enterprise to manipulate or use the data falls outside of the predefined modules, the enterprise has little choice but to either have a custom program written to accommodate the data manipulation need, or to have a separate program used to perform the desired task. Thus, a specialized enterprise, such as an insurance company, which may want a separate module for licensing which falls outside their ERP software offering, would be forced to use a separate software package for those functions, or simply do without. Since these specialized needs are seldom optional, the latter is not a viable option. Additionally, as mentioned, true data integration is not effected by current ERP software because of the modular nature of existing ERP software. Each module is still performing dedicated tasks separate and apart from the other modules or the main (core) module.

The consequence of these issues is the inherent ineffectiveness of the ERP software. By having to use software outside of the ERP for some functions, the entire purpose behind ERP, namely, the integration of data, is defeated. Data entry is once more spread among multiple software packages and data locations, and the inherent inefficiencies of multiple data entry, the cost of maintaining multiple data sets, and the possible data confusion and inconsistencies return to the enterprise and pose the same challenges as before.

The present invention of an integrated ERP system is thus a much-improved ERP software platform. The core engine of the present invention can interact with many modules that can be authored by the ERP software provider, or even authored by the enterprise itself. Custom or standard modules can be added at any time, and for any purpose, without having to retool the entire ERP package. Data fluidity is maintained, and concerns of data redundancy or multiple entries are eliminated, and the commensurate cost savings, time savings and other efficiencies are realized.

All of these aspects of the current mode of ERP lead to an increased need for a revised method of implementation with minimized cost and complexity, all of which the present invention addresses.

### OBJECTS OF THE INVENTION

One object of the invention is to provide a comprehensive ERP solution.

An additional object of this invention is to provide a blended integration of data.

Another object of this invention is to provide a reduction in code required to implement ERP.

Yet another object of this invention is to provide an ERP system that is expandable without modification of the basic architecture.

Still another object of this invention is to provide an ERP platform that is able to allow for concurrent development of extensions within the platform.

Still another object of this invention is to provide an ERP platform with an improved and unique search engine architecture.

Still another object is to provide an ERP platform with a point of integration at a record level rather than at an application level.

Other objects and advantages of this invention shall become apparent from the ensuing descriptions of the invention.

### SUMMARY OF THE INVENTION

According to the present invention, an improved ERP system is disclosed which provides for complete integration of systems across an enterprise in an infinitely expandable and easily deployable platform offering a vast reduction in overhead and learning curve, as well as extensive authoring, search, security and automation features.

### BRIEF DESCRIPTION OF THE DRAWINGS

The accompanying drawings and figures illustrate an embodiment of this invention. However, it is to be understood that this embodiment is intended to be neither exhaustive, nor limiting of the invention. They are but examples of some of the forms in which the invention may be practiced.

FIG. 1 is a graphical representation of the core engine.

FIG. 2 is a graphical representation of extensions in use.

FIG. 3 is a graphical representation of the first step in adding an aspect.

FIG. 4 is a graphical representation of the second step in adding an aspect.

FIG. 5 is a graphical representation of the third step in adding an aspect.

FIG. 6 is a graphical representation of the default search criteria.

FIG. 7 is a graphical representation of adding tabs to a search.

FIG. 8 is a graphical representation of a revised search criteria page.

FIG. 9 is a flow chart showing a sample of how the invention's search engine functions.

FIG. 10 is the first of three flow charts representing the invention's search engine's logic.

FIG. 11 is the second of three flow charts representing the invention's search engine's logic.

FIG. 12 is the third of three flow charts representing the invention's search engine's logic.

### DETAILED DESCRIPTION OF EXEMPLARY EMBODIMENTS

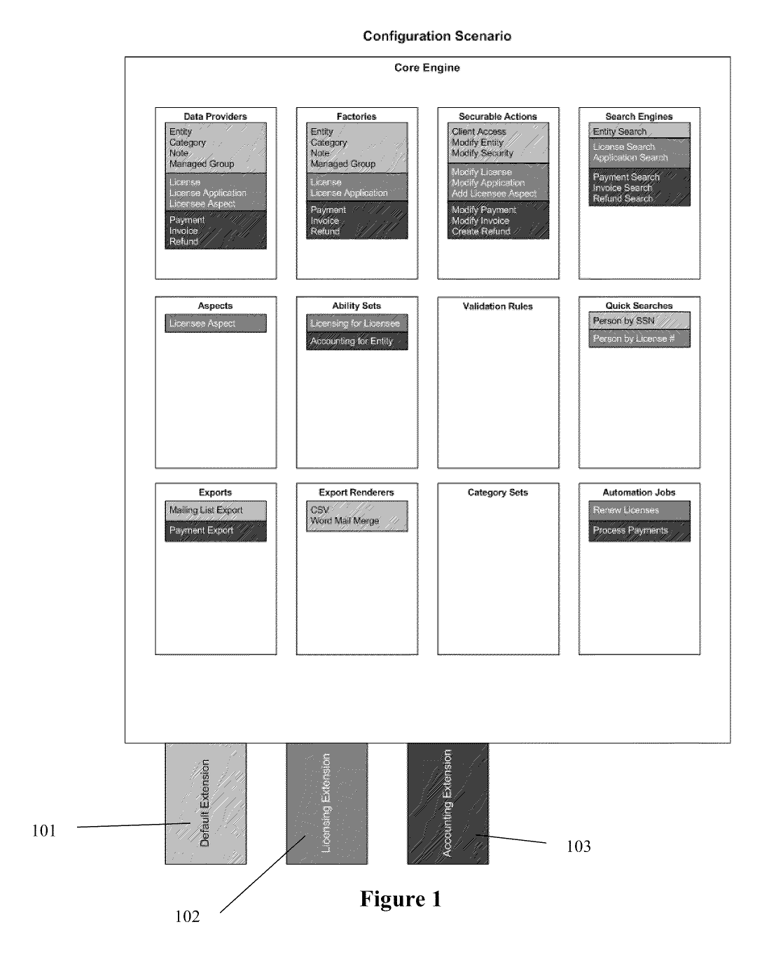

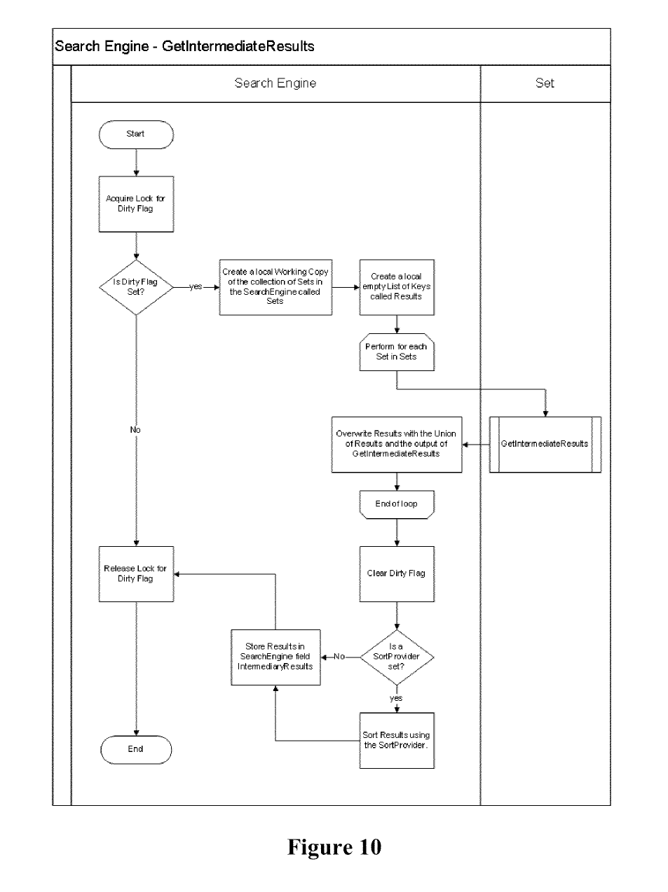

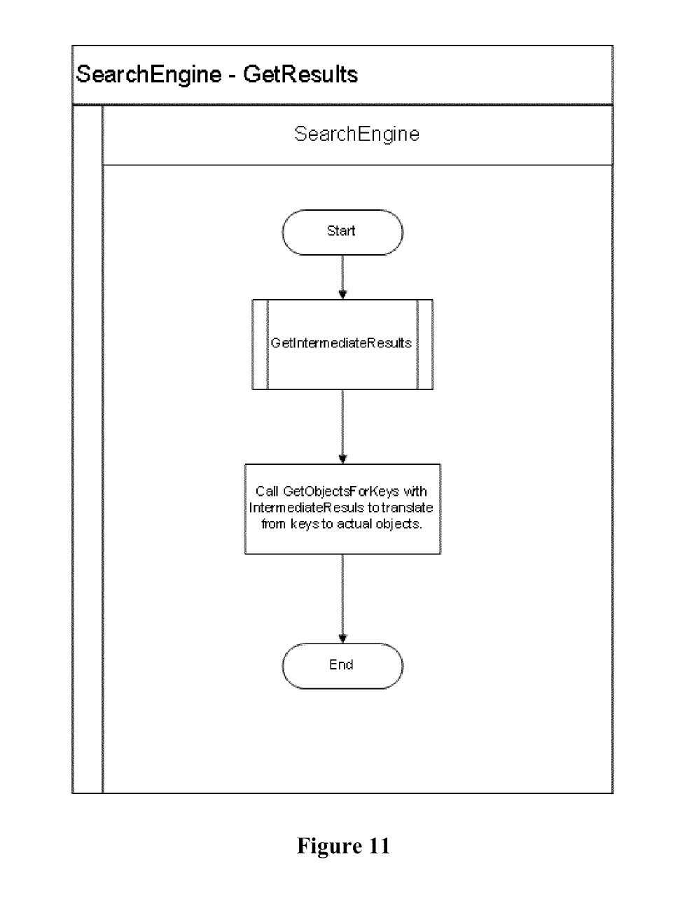

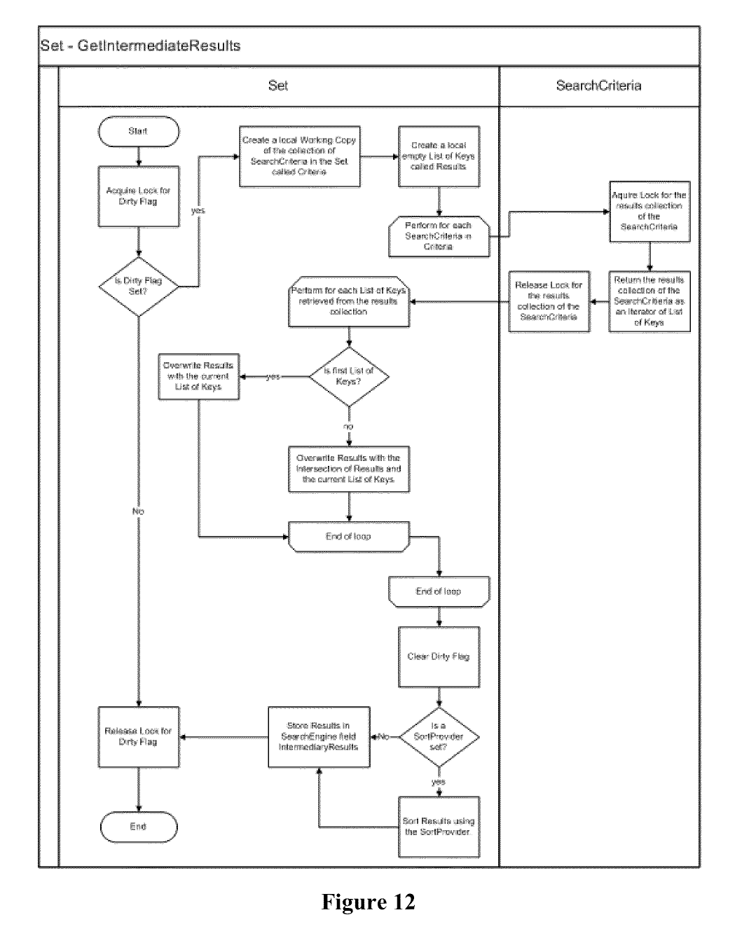

Without any intent to limit the scope of this invention, reference is made to the figures in describing the various embodiments of the invention. FIGS. 1 through 12 depict various aspects of exemplary embodiments of the present invention.

The present invention relates to an enterprise software platform, which is used to integrate data entry and storage tasks across an enterprise, or business, in order to aid in centralizing and consolidating data that is used by such enterprise, and to make such data more accessible, less redundant and easier to manage. The most common traditional analogous software is a database, which is utilized to store vast amounts of data about myriad things, such as customers, vendors, employees, licensees, and the like. While very powerful, databases leave much to be desired in terms of user friendliness, customization and expandability, particularly on a large scale.

Because of the trend in business of ever-increasing data use, the need for being able to access this data in multiple locations, by multiple people, for multiple reasons has rendered the traditional database virtually obsolete for such an enterprise-wide task. Additionally, the rapidly expanding number and types of software available for different tasks have caused data stratification and inconsistency that can only effectively be resolved by consolidating and streamlining the storage and access of this data across an enterprise. Furthermore, the ever-expanding use of data mandates that new ways of interfacing with the data be implemented. Therefore, the present invention has been conceived and is presented.

Entity-Level Integration

The present invention makes a significant novel contribution to the technological field of Enterprise Resource Planning (ERP) by utilizing “entity level” integration instead of “application level” integration.¹ To contrast these two concepts, in the existing art, ERP software revolves around the application, with different modules and add-ons, plug-ins or the like to add functionality working in connection with a centralized application. The consequence of this disjointed approach to ERP is data that is application-centric, and can only be accessed in relation to the software and/or modules being used. ¹An “entity,” as discussed in this context, refers to the status of a record as either a person or an organization, or in other words, the most basic distinction between a living person and a fictional entity.

This is addressed in a vastly different way in the present invention, where the entity becomes the focal point. Rather than programs being created which seek to access and manipulate the data, the entity data itself is essentially dictating what functions of the program access it, and in what way or ways. In this fashion, new additions to the invention can extend the platform by adding new capabilities to existing entities, rather than to the software architecture. This technology is referred to as “enterprise entity management” software, as an evolution of sorts of ERP software, rather than “application level” software, which lacks this capability.

This “entity level” approach is effected through a unique set of components, or engines, in the present invention. This “entity level” integration is explained further in the concepts presented below.

Ability Sets, Aspects and Views

As part of the entity-centric environment, other novel features are present. The three primary attributes of an entity in the invention are aspects, ability sets and custom business objects. These novel concepts enable an entity record to remain constant throughout changes, additions, deletions and modifications to the enterprise, its structure, its data, its business model—virtually anything. This is accomplished because the extensions can be written to add “ability sets,” “aspects,” and “views” to the existing entities, expanding their data-keeping capabilities and data-manipulation capabilities, as well as providing the power for a user to instantly be given access to enter the new information, specific to their role in the enterprise.

A framework of “views,” “ability sets” and “aspects” are introduced in the present invention, which define what data the entity can store and the nature of that entity (aspects), groups of functionality based on an aspect (ability sets) and what data is seen by the end user based on these two items (views).

Aspects can be added via extensions. An aspect blends data processes and workflow for a particular type of entity (e.g., vendor, employee, licensee). Any number of aspects can be designed through extensions by developers and end users can associate as many aspects to an entity as needed. These aspects are thus defined so that once an entity is assigned an aspect, that entity will automatically assume all the capabilities of that aspect as defined by the aspect. So, if there is a “licensee” aspect, and an entity is associated with that aspect, the entity automatically has all the capabilities of a “licensee” as defined by the aspect.

Secondly provided are ability sets, which add in groupings of functionality via extensions to perform certain tasks which are registered with particular aspects. Ability sets are repositories for a logical group of processes (such as, in a licensing context, cancellation, renewal, etc.), or a common set of capabilities of an entity. These ability sets can be applied to aspects which share functionality (for example, two entities that may access a common set of data) or applied to aspects in previous extensions, allowing the overall functionality of system to grow without impacting previous code. As an example, if the enterprise requires an application to process payments, this ability set can be written and associated with any number of aspects so that they might all use the newly-added payment ability set.

Another element of the present invention is the use of shared and isolated ability sets, which is a nuanced development of the above. A developer can assign an aspect and register it with an ability set. In the case of shared ability sets, the same module is loaded in both aspects, as opposed to isolated, whereby a developer may tie an extension to a particular role (aspect). For example, displaying invoices can be done for a multitude of reasons. Since a “customer” and a “licensee” of insurance products are likely to have invoices for different reasons, the ability set would be isolated to each role. Compared then to a “customer” and a “vendor,” however, the roles may involve the same type of invoicing, and thus could be a shared ability set.

To further customize the user experience, views can be employed in the end user interface as well, whereby the aspect specifies capabilities of the entity, thus defining what a certain user will or will not see. This reveals the features of the entity. In essence, views create a quasi-subsystem to display the information in the user environment. For example, if an accountant wants to see just “accounting” information, that can be specified by selecting that particular view. This functionality is defined in the extension. Views thusly provide yet an additional layer of customization and control to both the enterprise and the user, all through the extension architecture.

The capability of the present invention to manipulate data and processes is unique in that, among other things, changes are not only made in how the data is stored, but how the data is presented to the user based upon the functionality added by the extensions, all from within the primary program.

This is vastly different from existing art because traditional ERP software will not allow the user to tell if an entity is present in other modules, that is, if a module is open to view a record based on an “accounting capability,” that user will have no idea if or how that same user is also in another system, such as “licensing,”—resulting in a “segmented” effect, since the “big picture” of the entity being viewed cannot be appreciated from individual modules. Compare this to the present invention, however, where information is instantly viewable from any pane and from any extension, and since all users work from the same central engine, all data about an entity may be accessed and viewed, depending on the selection or selections of an end user.

Invention Core Components

### Integration Engine

The primary component of the enterprise software platform as disclosed is the integration engine. This engine is designed to store information about various core objects, the most primary of which is termed an “entity.” This so-called entity can be either classified by the software as an individual or an organization, as these are the two most basic types of “entities” in real-life situations. From that point, the details of this entity, such as address, name, and so forth can be read, stored and manipulated by the integration engine. This integration engine also serves as the hub by which all other engines, extensions, and ancillary process flow through, maintaining a centrally-located and expandable center of processing for the present invention.

Another purpose of this integration engine is, as the name would suggest, integrating the entity data with other subengines, used for handling and presenting the entity data, as well as integrating extensions, (somewhat analogous to modules in traditional ERP, and explained in detail below) which can be added to the enterprise software platform to increase functionality, flexibility, and/or tailor the operation to a specific need. In this way, processes are actually integrated with the data as well. For example, an extension can be added to provide a new function to a retail enterprise for shipping and receiving, or for accounts payable. Likewise, if a retail enterprise begins exporting goods, an extension may be added to deal with information that is needed for customs. The data for these tasks then is not only expanded in scope with the addition of an extension, but with the present invention, the data can be presented and manipulated uniquely depending on its own characteristics.

### Subengines

To add basic functionality to the integration engine, various subengines can be included with the integration engine. The primary subengines included are the search engine, a security engine, a notes engine, an automation engine and a configuration engine. Any number and any type of other engines may also be added to address any data or process concern.

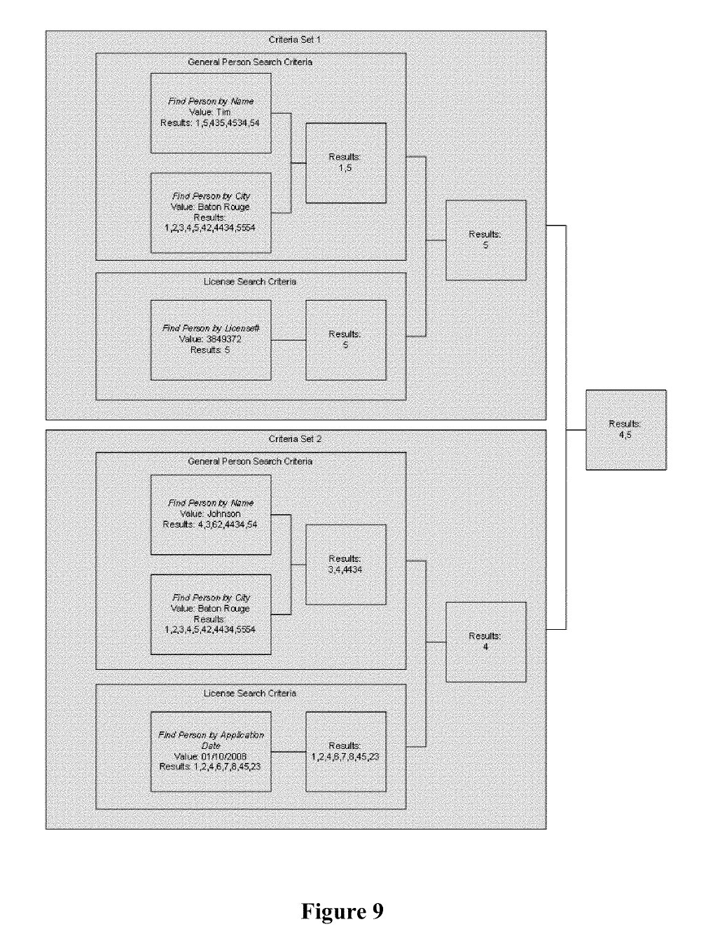

The search engine is capable of performing a unique search query which is accomplished by accepting criteria from a user via an input/output device, but then instead of looking for the individual criteria among records that match the criteria, several parallel searches are performed on each individual criteria provided by a user. Each parallel search then returns the IDs of the entity records which match the desired criteria, and the search subengine performs a union operation on the results to display, in real-time, the amalgamation of the parallel searches run by the search engine. This novel approach to search is useful not only in the context of the enterprise software model, but could, in practice, be used in any number of applications. An example of this logic can be seen in FIGS. 9-12.

Searches, as mentioned, are employed using a unique mechanism that runs parallel searches by adding criteria from any built-in attribute of the core object or entity, as well as any criteria from an extension added to the enterprise platform. Each criteria selected is run in a separate search as described above to render a result based on several searches that meets all the individual criteria selected by the user.

These searches are extendable, that is to say that features or criteria can be added dynamically by the user. This search architecture is thus a way of finding information based on anything that is present. Existing search technology generally use predefined criteria to perform a search, such as offering specified fields to search. In the present invention, however, the query is not predefined. The end user may specify to run a search for each section of a query. Then, the union function for the search results is moved from query to extension, enabling the end user to formulate their own searches.

As an additional feature of the search engine, searches may be conducted across several different databases simultaneously, without further user involvement. The advantages of such a search feature are immediately evident; however it is the unique parallel search architecture that enables this functionality.

The notes engine allows for the integration engine to automatically annotate entries about an entity when various operations are performed. For example, if an entity is modified, the notes engine can automatically record who modified the record, when it was modified, and from what location. In this fashion, an audit trail can be effectively kept by the enterprise software to help ensure accountability.

The automation engine allows for routine tasks to be initiated automatically by the enterprise software. If, for example, an entity must renew its license every year based on its date of birth, the automation engine can be configured to run a corresponding automation task that dispatches e-mails, letters, or phone calls to entities which may be in need of a renewed license.

The security engine within the enterprise software is employed to control which users can view, modify or remove entities and their data. The enterprise can choose levels of security in various fashions to control the data that is viewable to a user or set of users, and likewise, control the data that is editable by a user of group of users.

The configuration engine is a built-in subengine that permits users of the enterprise software to configure various data that are used throughout the enterprise. In a retail enterprise, for example, sales tax rates would need to be known, and this information can be configured in the configuration subengine.

To interact with the integration engine, an input/output device is provided, which can be any number of well-known devices in the art used to permit an operator of the system, or user, to input data to be used by the enterprise resource platform, to display data to the user, to store data on a medium, to transmit data across a network and the like.

As part of the input/output device as described above, any number of user interfaces can be provided, such as those on a personal computer, thin client, handheld or the like. In using that interface, varying views can be employed to customize and control what the end user sees based on his role in the enterprise.

Extensions

Another unique aspect of the present invention, and a focal point of novelty, is the capability to allow third party developers to dynamically extend the capabilities of a system via extensions, therefore increasing the functionality of the entire system as a result of being seamlessly exposed to existing entity functionality, or a blended integration of data and application. These extensions are written to perform certain tasks with relation to the data, and rather than performing tasks on their own, enable the software as a whole, and the entities themselves, to perform additional tasks and expand their functionality.

To this basic formula for the enterprise resource platform, then, the functionality can be expanded by using these extensions. One or more extensions can be added to the integration engine in order to expand or refine what the integration engine is able to do with the data it stores on entities. These extensions can also manipulate and vary the way in which the data is presented to the user, and how the user interacts with said data. For example, an extension may be added which permits the storage of additional data points about an individual, but they can also alter and enhance how that data is presented to a particular user. This virtually limitless expandability and configurability is primarily accomplished by an extension adding an ability set, an aspect and/or view to the entities' data abilities.

Examples of such extensions include a “licensing” extension for real estate agents if the user has particular needs for data manipulation for licensing, or an “export” extension if a user needs to maintain data on tariffs and the like. Any number or type of extensions may be added, so that the entity (and thus, the software as a whole) need not be limited or constrained by the tasks required of it, nor should the present invention be susceptible to obsolescence, since it is infinitely expandable and adaptable.

In the existing art, if a system required expansion into a new area, a plug-in or module could be authored that would either add a new interface within which to manipulate the newly added data, or the system as a whole could be rewritten to include functionality that was not present before. Though this was advantageous from the standpoint of several “modules” or programs being able to read the same data records for different purposes, which was admittedly an improvement over having a multitude of programs, this resulted in segmentation of data as it is presented to the user.

In contrast, now, by only adding an extension, the capability to store the newly needed data can be added, as well as a modification of the structure of the data's presentment to the user, with both as customizable, fully modular system. These abilities can also be tied to a record within the data, wherein the record itself is determined to be a particular type by the extension, and for each particular type, the “ability” of that record changes. For example, if an individual record is both an insurance agent and an insurance adjuster, each of those roles will enable the extension to determine the “abilities” of that record. For each extension, any number of aspects and abilities may be defined. This “blended integration” is again demonstrated here, as not only is the data being stored dynamic, and not only is the data presentment to the user dynamically, but the data itself has a role in making its identity dynamic to both the end-user and the system.

So, it can be seen that in this way, the overall amount of code and coding is drastically reduced. Extensions can be added at any time, and to any extent desired, without having to plan for the expansion at the outset of the implementation of the enterprise resource platform. Because of this eliminated need to plan individual components, extensions can be developed concurrently by different users, they can be authored at different times, be from different sources—all integrated into a single system. Views, aspects and ability sets can be implemented to adapt to new tasks. These attributes, working together, enable the blended integration of systems across an enterprise, while simultaneously serving only the desired data to only the desired people at only the desired time. This basic structure of ability sets, aspects, and views being expandable into the main integration engine via extensions provides a robust and dynamically expandable novel system of data management.

In operation, then, an enterprise application platform is designed with an integration engine supplied with one or more subengines as enumerated above, and is equipped to, at the direction of a user and via an input/output device, store information about core objects, namely, entities. The user can then utilize the various subengines to configure the enterprise application's various subsystems, such as security, automation, configuration and the like to tailor the enterprise application to his needs.

FIG. 1 demonstrates the various plug-in points exposed through the integration engine that are available for the invention's extensions to exploit. FIG. 1 shows three sample extensions installed in the integration engine: a default extension 101, a licensing extension 102, and an accounting extension 103. The diagram shows how the plug-in points that are available in the integration engine are utilized by the extensions as well as sample processes and business objects the extensions may define for this scenario.

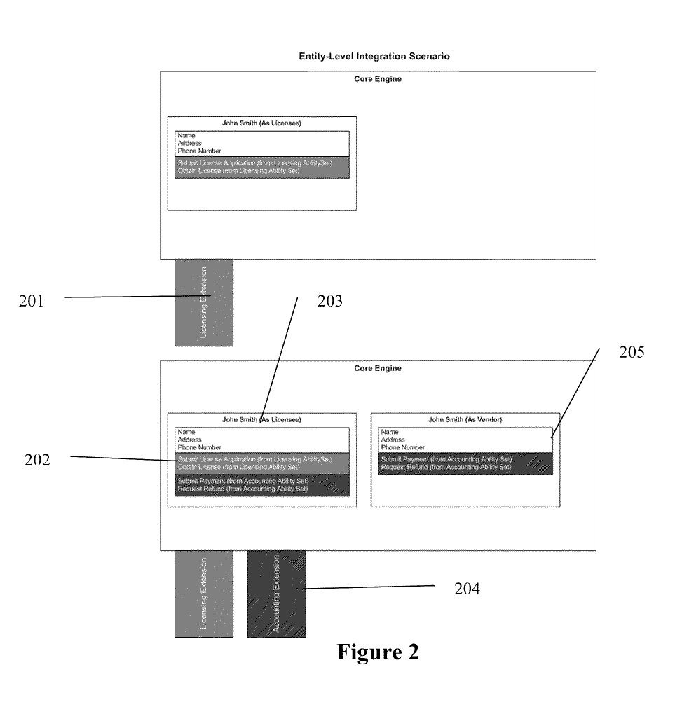

FIG. 2 demonstrates integrates various extensions at the entity level as opposed to the traditional approach of integrating at the application level. Through the use of aspects, new abilities can be added to existing entities in the system and to particular entity types. This unique approach to integration allows an organization to grow the novel system presented herein over time.

In FIG. 2 a licensing extension 201 that defines a “Licensee” aspect is presented. The extension further defines processes for this aspect such as “Submit a license application” and “Obtain License” 202. This aspect exposes these processes to entities in the ERP system that have been assigned the “Licensee” aspect 203.

Also included in FIG. 2, an accounting extension is added 204. This extension adds new processes to the existing “Licensee” aspect such as “Submit Payment” and “Request Refund”. The extension further defines a new aspect called “Vendor” 205 and adds these processes to entities that have been assigned that aspect as well.

Extensions can be added at any time, and in any quantity, to add functionality to the core objects. As part of this functionality, ability sets and aspects are utilized, which define what data the entity can store and the nature of that entity (ability set) and what data is seen by the end user based on that extension (aspects).

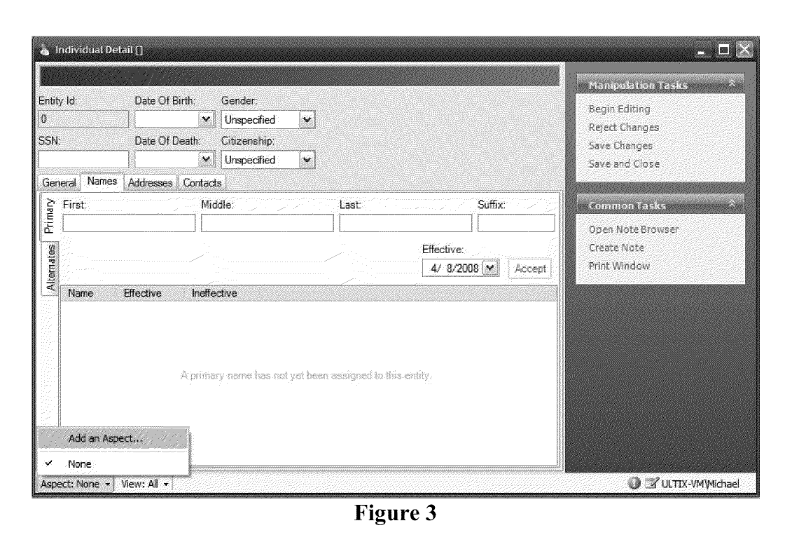

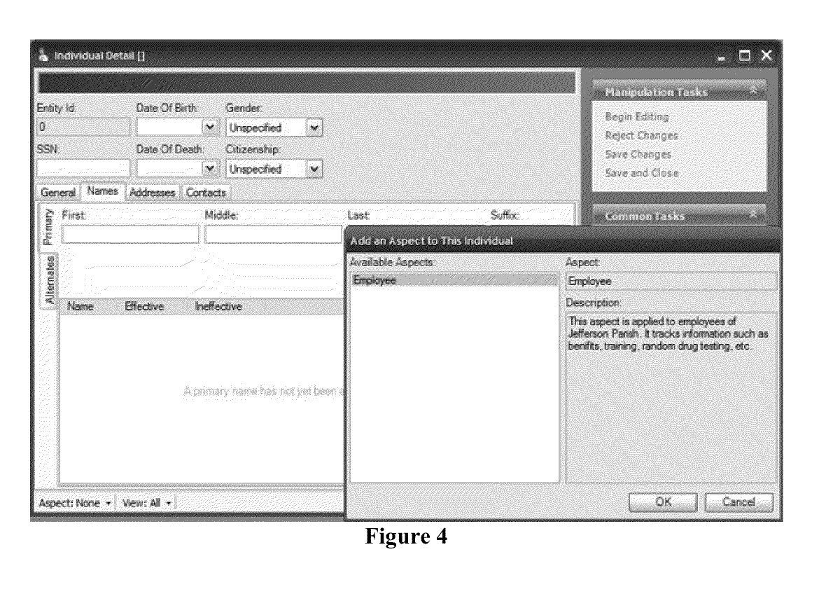

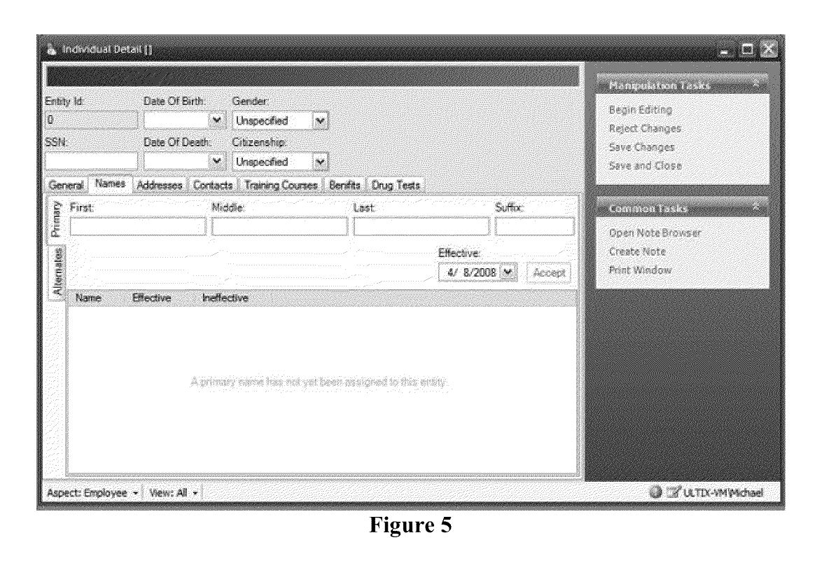

Adding an aspect to an entity is a simple prospect as seen in FIGS. 3-5. The add aspect dialog may be selected as in FIG. 3, an aspect chosen to be added to an entity as seen in FIG. 4 and finally, the newly added aspect is available to the entity record as seen in FIG. 5.

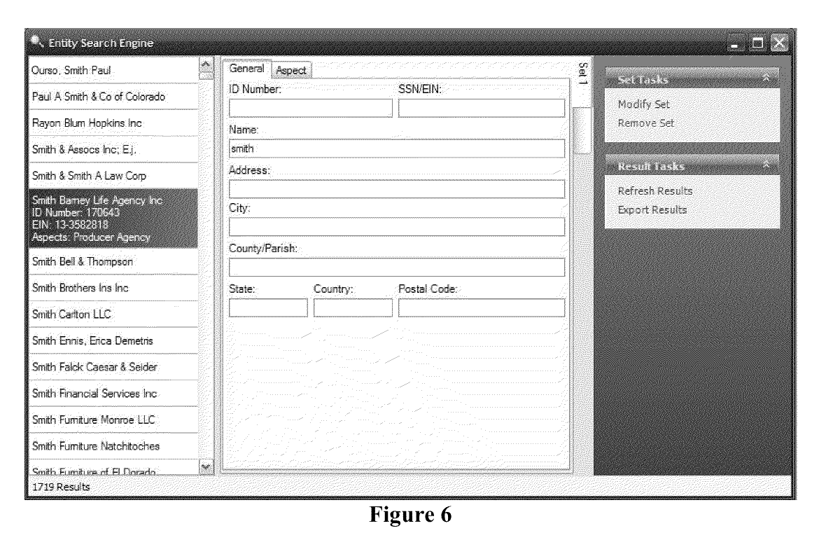

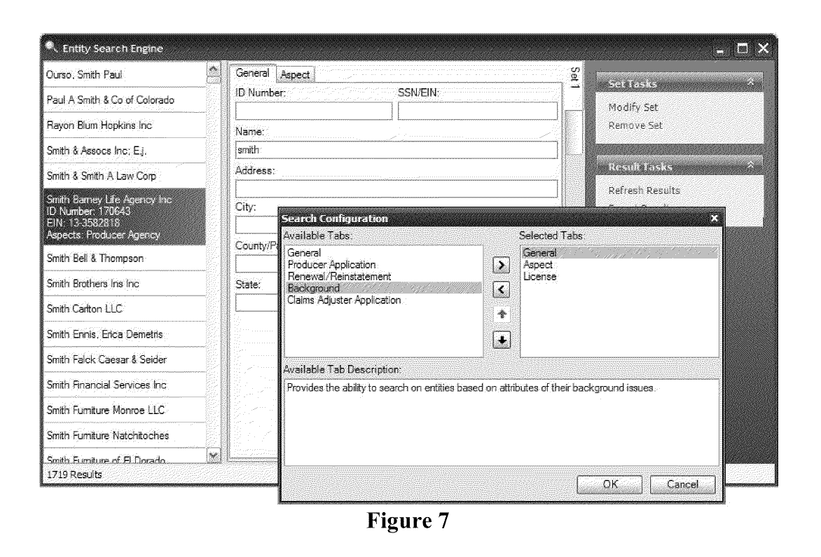

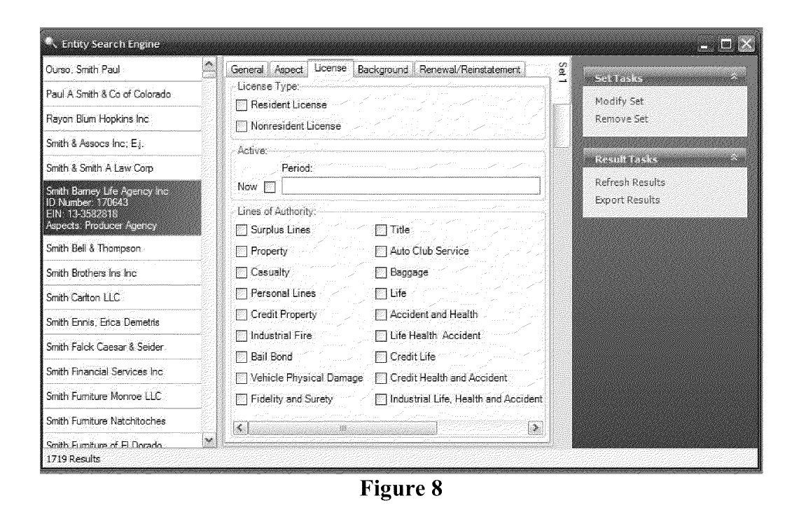

An example of the operation of the unique search engine process can be seen in FIGS. 6-8. The default search criteria is shown in FIG. 6, and by clicking “modify set” as seen in FIG. 7, additional tabs, or search criteria, can be added to the search set. Finally, in FIG. 8, the resulting added sets are seen and the search can be executed based on criteria from any of those sets.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

The invention claimed is:

1. An enterprise application platform designed for use by at least one user comprising:
a. an integration engine;
b. at least one core object which is readable by said integration engine;
c. at least one sub-engine configured to interface with said integration engine and is further configured to read and manipulate said core object through said interface with said integration engine; and
d. at least one input/output device.

2. The enterprise application platform of claim 1 further comprising at least one extension operatively configured to interface with said integration engine to define at least one ability set and at least one aspect set in relation to said core object.

3. The enterprise application platform of claim 2 further comprising a user interface configured to present said core object to said user on said input/output device based on said aspect set.

4. The enterprise application platform of claim 1 wherein said subengine is a search engine configured to retrieve said core object based on input received from said input/output device.

5. The enterprise application platform of claim 4 wherein said search engine is further configured to:
a. accept at least one criterion from said user on said input/output device;
b. retrieve a set of all core objects matching each said criterion;
c. perform a union function on said set; and
d. displaying records generated from said union function to said user on said input/output device.

6. The enterprise application platform of claim 1 wherein said subengine is a security engine.

7. The enterprise application platform of claim 1 wherein said subengine is a notes engine.

8. The enterprise application platform of claim 1 wherein said subengine is an automation engine.

9. The enterprise application platform of claim 1 wherein said subengine is a configuration engine.

10. The enterprise application platform of claim 6 further comprising a notes engine.

11. The enterprise application platform of claim 6 further comprising an automation engine.

12. The enterprise application platform of claim 6 further comprising a configuration engine.

13. The enterprise application platform of claim 7 further comprising an automation engine.

14. The enterprise application platform of claim 7 further comprising a configuration engine.

15. The enterprise application platform of claim 8 further comprising a security engine.

16. The enterprise application platform of claim 1 further comprising a views system for said input/output device configured to display information to said user based on selectable data.

17. An enterprise aware search application for retrieving core objects designed for use by at least one user comprising:
a. an integration engine configured to store at least one core object;
b. at least one input/output device;
c. a search engine configured to retrieve any core object which matches input received from said input/output device.

18. The enterprise aware search application of claim 17 wherein said search engine is further configured to:
a. accept at least one criteria from said user on said input/output device;
b. retrieve any core objects matching each said criteria;
c. perform a union function on said records matching said criteria; and
d. display core objects generated from said union function to said user on said input/output device.

19. The enterprise application platform of claim 2 wherein:
a. said aspect set defines at least one first group of data an entity can store;
b. said ability set defines at least one second group of data which defines at least one type of functionality and which is linked to at least one aspect set; and
c. further comprising at least one view configured to define what data is viewable by said user based upon the parameters of said aspect set and said ability set.
